(19) United States
(12) Patent Application Publication
(10) Pub. No.: US 2026/0176900 A1
(43) Pub. Date: Jun. 25, 2026

(54) TANK LID HINGE ASSEMBLY FOR FLOOR TREATMENT MACHINES

(71) Applicant: NILFISK A/S, Copenhagen (DK)

(72) Inventor: Nicholas John Davis, Maple Grove, MN (US)

(21) Appl. No.: 18/987,469

(22) Filed: Dec. 19, 2024

(51) Int. Cl. E05D 3/02; A47L 11/24; A47L 11/30; A47L 11/40

(52) U.S. Cl. CPC E05D 3/022; A47L 11/24; A47L 11/305; A47L 11/4016; A47L 11/4044; A47L 11/4083

(57) ABSTRACT

A hinge assembly for pivotably maintaining a lid relative to an opening of a tank body of a floor treatment machine. The hinge assembly includes a post, a base body, and a bracket. The post projects from a side of the lid. The base body defines a slot. The bracket is configured for connection to the base body in a region of the slot. Upon final assembly, the bracket captures the post within the slot in a manner permitting the post to selectively rotate relative to the bracket and relative to the base body.

### BACKGROUND

The present disclosure generally relates to floor treatment machines. More particularly, it relates to hinge assemblies useful with a tank lid for a floor treatment machine.

Industrial and commercial floors are cleaned on a regular basis for aesthetic and sanitary purposes. There are many types of industrial and commercial floors ranging from hard surfaces such as concrete, terrazzo, wood, and the like, which can be found in factories, schools, hospitals, and the like, to softer surfaces such as carpeted floors found in restaurants and offices. Various types of mobile floor cleaning machines having different sizes and capabilities (e.g., vacuums, scrubbers, sweepers, and extractors) have been developed to properly clean and maintain these different floor surfaces.

Ride-on and walk-behind machines are conventionally employed to efficiently clean or otherwise treat larger-scale floors. A typical wet-process floor treatment machine applies a liquid cleaning solution or fluid from an on-board cleaning solution supply tank onto the floor through nozzles. Rotating brushes agitate the applied solution to loosen dirt and grime adhering to the floor. The dirt and grime become suspended in the solution, which is collected by a vacuum squeegee carried by a rearward portion of the machine and deposited into an onboard recovery tank. Additional cleaning implements (brushes, pads, etc.) can also be provided with, and operated by, the floor treatment machine. Also, with some designs, the floor treatment machine can carry one or more bins or hoppers into which collected debris is stored.

One or more of the various storage receptacles provided with many floor treatment machines (e.g., recovery tank, supply tank, collection bin, etc.) typically includes a tank body (or container-like structure) and a lid. With some designs, the lid is pivotably maintained relative to the tank body by one or more hinge mechanisms. An operator can readily articulate or pivot the lid between a closed position (in which the lid covers an opening of the tank body) and an opened position (allowing access to an interior of the tank body). In many instances, a gasket or similar body is provided between the tank body and the lid to effect a seal between the lid and the tank body in the closed position. With these and similar arrangements, the hinge mechanism(s) is desirably configured to facilitate necessary radial movement of the lid relative to the tank body while in the closed position so as to achieve relatively uniform compression across the gasket when an interior of the tank is placed under negative pressure. Regardless of the exact design, a metal hinge is conventionally attached to both the lid and a structure of the tank body with number of fasteners (e.g., screws, molded inserts, etc.). While well-accepted, it can in many instances be exceedingly difficult to consistently secure a hinge to various bodies, for example rotationally molded (rotomolded) chassis structures desirably employed with some floor treatment machines, and/or to access the desired hinge installation location.

### SUMMARY

The inventor of the present disclosure has recognized a need to address one or more of the above-mentioned problems.

Some aspects of the present disclosure relate to a hinge assembly for pivotably maintaining a lid relative to an opening of a tank body of a floor treatment machine. The hinge assembly includes a post, a base body, and a bracket. The post projects from a side of the lid. The base body defines a slot. The bracket is configured for connection to the base body in a region of the slot. Upon final assembly, the bracket captures the post within the slot in a manner permitting the post to selectively rotate relative to the bracket and relative to the base body. In some embodiments, the bracket defines a capture region configured to capture a portion of the post. With these and other examples, the bracket can include a leg having a C-like shape to define the capture region and the post includes a finger carrying a pivot member; upon final assembly, a portion of the pivot member is disposed within the capture region and the finger is free of the capture region. In some embodiments, the bracket defines a capture region configured to capture a portion of the post with the captured portion of the post being laterally moveable within the capture region.

Other aspects of the present disclosure relate to a floor treatment machine including a chassis, at least one floor treating implement carried by the chassis, and a tank unit carried by the chassis. The tank unit includes a lid, a tank body, and a hinge assembly pivotably maintaining the lid relative to an opening of the tank body. The hinge assembly includes a post, a base body, and a bracket. The post projects from a side of the lid. The base body defines a slot. The bracket is configured for connection to the base body in a region of the slot. Upon final assembly, the bracket captures the post within the slot in a manner permitting the post to selectively rotate relative to the bracket and relative to the base body. In some embodiments, the at least one cleaning implement is selected from the group consisting of a scrubber, a sweeper, an extractor, and a squeegee.

### BRIEF DESCRIPTION OF THE DRAWINGS

FIG. 1 is a perspective view of an example floor treatment machine that can include one or more hinge assemblies of the present disclosure;

FIG. 2A is a perspective view of an example tank unit useful with a floor treatment machine, including a hinge assembly of the present disclosure maintaining a lid of the tank unit in a closed position;

FIG. 2A is a perspective view of the tank unit of FIG. 2A with the lid in an opened position;

FIG. 2C is a perspective view of the tank unit of FIG. 2A with the hinge assembly in an exploded form including a post, a base body, and a bracket;

FIG. 3A is a perspective view of a post useful with the hinge assemblies of the present disclosure;

FIG. 3B is a side view of the post of FIG. 3A;

FIG. 3C is an end view of the post of FIG. 3A;

FIG. 3D is a top view of the post of FIG. 3A;

FIG. 4A is a perspective view of a portion of a base body useful with the hinge assemblies of the present disclosure;

FIG. 4B is a top view of the base body portion of FIG. 4A;

FIG. 4C is an end view of the base body portion of FIG. 4A;

FIG. 5A is a perspective view of a bracket useful with the hinge assemblies of the present disclosure;

FIG. 5B is an end view of the bracket of FIG. 5A;

FIG. 5C is a top view of the bracket of FIG. 5A;

FIG. 5D is a side view of the bracket of FIG. 5A;

FIG. 6A is a bottom perspective view of the bracket of FIG. 5A, illustrating optioning engagement members provided with the bracket;

FIG. 6B is a top perspective view of the bracket arrangement of FIG. 6A and optional fastening bodies exploded from the bracket;

FIG. 7 is an exploded, perspective view of a portion of the base body of FIG. 4A and the bracket arrangement of FIG. 6B;

FIG. 8 is a bottom, perspective view of the arrangement of FIG. 7 upon final assembly;

FIG. 9 is a simplified, cross-sectional view of a portion of the arrangement of FIG. 8;

FIG. 10 is an exploded perspective view of the post of FIG. 3A and the bracket of FIG. 5A;

FIG. 11 is an end view illustrating the arrangement of FIG. 10 upon final assembly;

FIG. 12 is a simplified, cross-sectional view of portions of the hinge assembly of FIG. 2A; and

FIG. 13 is a top view of the hinge assembly of FIG. 2A.

### DETAILED DESCRIPTION

Some aspects of the present disclosure are directed to hinge assemblies for pivotably maintaining a lid relative to an opening of a receptacle, for example a lid for a provided with a floor treatment machine. The hinge assemblies of the present disclosure are easy to install and are well-suited for use with molded components.

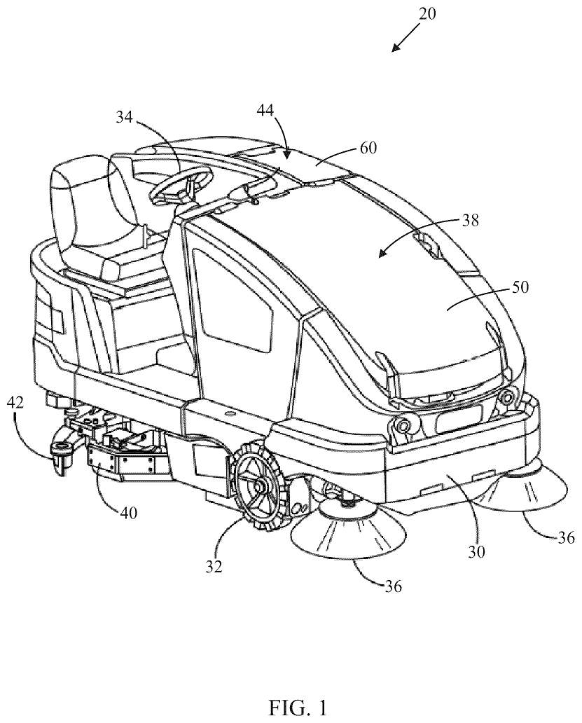

The hinge assemblies of the present disclosure can have a number of end-use applications, and in some example are utilized with a floor treatment machine, such as including known or available ride-on, walk-behind, push-type, partially autonomous, or fully autonomous floor treatment machines configured as a scrubber machine, a sweeper machine, a vacuum machine, or a combination thereof. One non-limiting example of a floor treatment machine 20 of the present disclosure is shown in FIG. 1 and includes a chassis 30 (referenced generally) that maintains wheels 32, a steering component 34, cleaning elements 36, a hopper assembly 38 (referenced generally), a scrubber assembly 40, a squeegee assembly 42, and a recovery tank assembly 44 (referenced generally). Though hidden in the view, the floor treatment machine 20 can include a power source (e.g., battery, combustion engine, etc.) and a drive system that transmits power from the power source to one or more or all of the wheels 32.

The wheels 32 (only one is visible in FIG. 1) are connected to the chassis 30 (e.g., via a suspension system) and are configured to facilitate at least one of steering, driving, or a combination thereof of the floor treatment machine 20. The steering component 34 is provided as part of a steering system that further includes a steering transmission assembly (hidden) connected to the steering component 34. The steering component 34 is a physical device for receiving at least steering input from an operator. For example, the steering component 34 can include at least one of a wheel, a handle, a knob, or a combination thereof. The steering transmission assembly is configured to translate or transmit movements of the steering component 34 to one or more or all of the wheels 32.

The cleaning elements 36 can be sweeper elements, such as rotating or spinning sweeper elements. In other embodiments, floor treatment machines of the present disclosure can include a cylindrical brush sweeping elements. Additionally, or alternatively, the floor treatment machine 20 can include a vacuum to draw air, particulate, and/or water into the machine. The hopper assembly 38 includes a container for storing dry debris collected by the floor treatment machine 20. For example, the hopper assembly 38 can define a cavity configured for receiving and collecting debris picked up from a cleaning surface by the floor treatment machine 20 (e.g., by way of cleaning elements 36 or another component of the floor treatment machine 20). The so-defined cavity can be selectively covered by a hopper lid 50 that can be pivotably coupled relative to the chassis 30 by one or more hinges, optionally by way of a hinge assembly of the present disclosure.

The scrubber assembly 40 can be configured to provide a cleaning action to the floor, such as rotary disc, orbital or cylindrical cleaning. In some embodiments, then, the scrubber assembly 40 can include one or more rotating brushes. Fluid from a liquid system (hidden) can be dispensed in a region of the scrubber assembly 40 to enhance scrubbing performed by the scrubber assembly 40. In this regard, the liquid system can include an on-board cleaning solution supply tank, a pump, nozzles, and conduit(s) fluidly connecting the supply tank to the nozzles. A supply tank lid can be pivotably coupled relative to the chassis 30 by one or more hinges to selectively cover the supply tank, optionally by way of a hinge assembly of the present disclosure.

The squeegee assembly 42 can be used to corral or wipe dirty liquid behind the scrubber assembly 40, with the so-collected liquid being delivered to/stored by the recovery tank assembly 44. For example, a vacuum source can operate to draw liquid from a region of the squeegee assembly 42 through an on-board recovery conduit or hose to a tank body of the recovery tank assembly 44. A recovery tank lid 60 provides access to the internal volume of the recovery tank body, and can be pivotably coupled relative the chassis 30 by one or more hinges, optionally by way of a hinge assembly of the present disclosure.

It will be understood that the floor treatment machines of the present disclosure can include additional features (e.g., control system components, control panel/user interface), sensors, safety features, etc.) and/or omit one or more of the features described above. For example, in other embodiments, the floor treatment machines of the present disclosure can be configured or formatted as a walk-behind machine, a push-type machine, an autonomous machine, or a partially-autonomous machine. In more general terms, the floor treatment machines of the present disclosure include or carry at least one cleaning implement or element for performing one or more intended floor treatment operations (e.g., brushes/scrubbers, collection hopper, solution tank and corresponding pump/spray components, liquid recovery tank, squeegee(s), vacuum source, extractor, etc.), and at least one storage tank (e.g., recovery tank, supply tank, hopper, receptacle, etc.) that is selectively covered by a lid that in turn is pivotably maintained relative to an opening of the tank by a hinge assembly of the present disclosure.

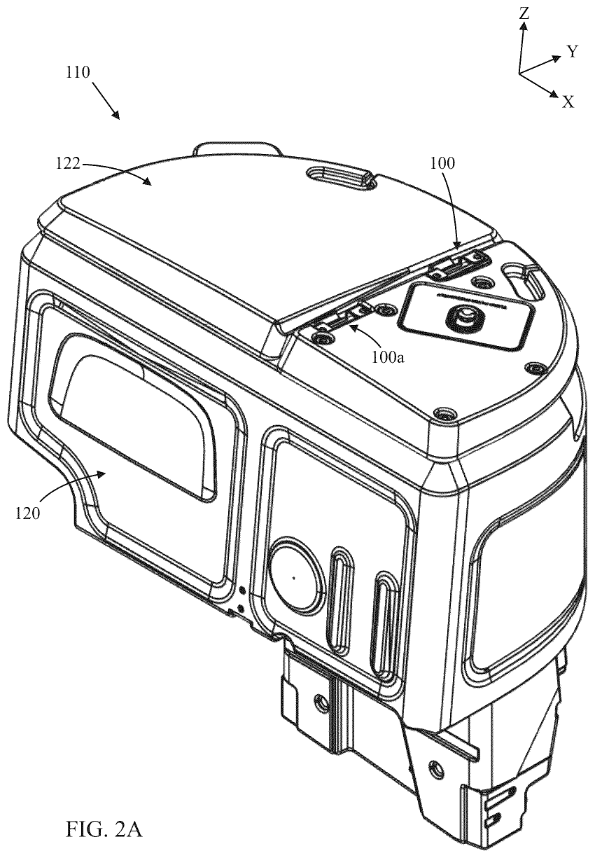

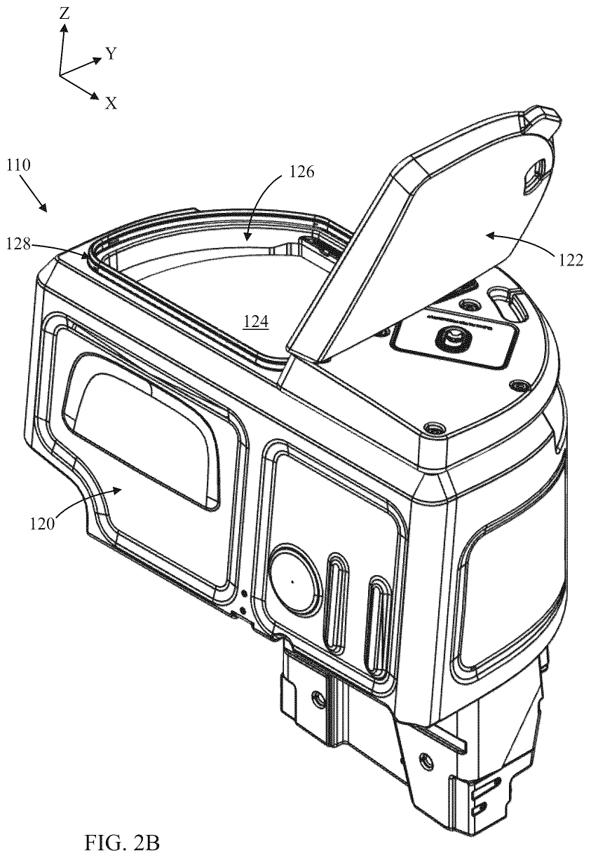

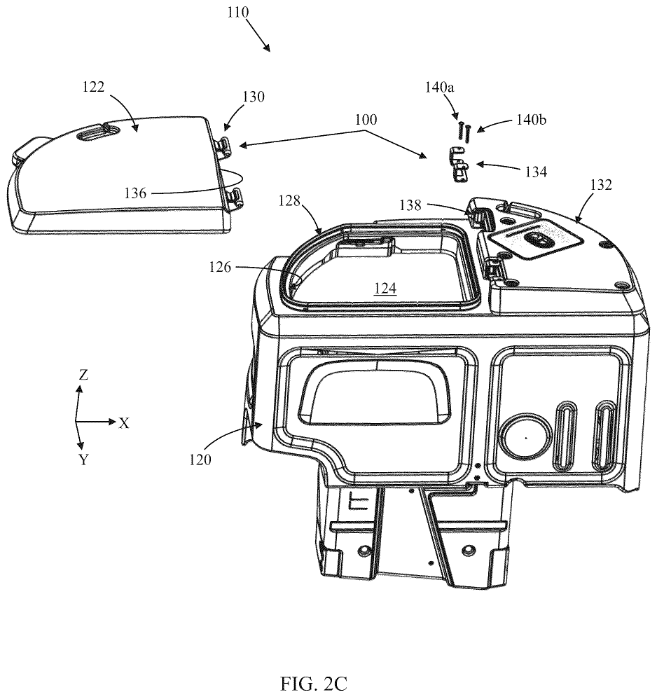

With the above background in mind, one embodiment of a hinge assembly 100 in accordance with principles of the present disclosure provided with or as part of a floor treatment machine tank unit 110 that generally includes a tank body 120 and a lid 122 is shown in FIGS. 2A and 2B. The hinge assembly 100 is arranged to pivotably maintain the lid 122 relative to the tank body 120, permitting the lid 122 to be pivoted from the closed position of FIG. 2A to an opened position reflected by FIG. 2B as described in greater detail below.

As a point of reference, with the non-limiting example of FIG. 2A, two of the hinge assemblies 100 are provided (with a second one of the hinge assemblies being labeled as 100a). In other examples, a floor treatment tank can be provided with a single hinge assembly 100, or three or more hinge assemblies 100. Further, it will be understood that the tank body 120 and/or the lid 122 can assume a wide variety of forms that may or may not substantively differ from the formats reflected by FIGS. 2A and 2B. In more general terms, and with additional reference to FIG. 2C (in which the lid assembly 100 is shown in exploded form, including the lid 122 being apart from the tank body 120), the tank body 120 can have any shape, size or format suitable for implementation with the overall design of the corresponding floor treatment machine (e.g., the tank body 120 can be assembled to or formed by a chassis of the floor treatment machine), and in some examples can be a rotomolded plastic part. Regardless of an exact shape or size, the tank body 120 defines an interior cavity 124 that is accessible at, and open relative to, an opening 126. The lid 122 is sized and shaped to cover the opening 126 when arranged in the closed position of FIG. 2A, and in some examples can be a rotomolded plastic part. FIGS. 2B and 2C reflect that in some non-limiting examples, the tank unit 110 can include a gasket or similar sealing body 128 to effect a seal between the tank body 120 and the lid 122 in the closed position. Although the gasket 128 is depicted in FIGS. 2B and 2C as being carried by the tank body 120, in other embodiments, the gasket 128 can be mounted to an underside of the lid 122. It will be further understood that additional components or features can optionally be provided with the tank unit 110 (e.g., vacuum source, filter, etc.).

As best seen in FIG. 2C, the hinge assembly 100 includes a post 130, a base body 132, and a bracket 134. Details on the various components are provided below, and can be commonly described with respect to the X, Y, Z coordinate system provided in FIGS. 2A-2C. In general terms, the post 130 projects from a side 136 of the lid 122. The base body 132 defines a slot 138. The bracket 134 is configured to receive at least a portion of the post 130 and for connection to the base body 132 in a region of the slot 138, for example via one or more fastening bodies, such as fastening bodies 140a, 140b. Upon final assembly, the bracket 134 captures the post 130 within the slot 138 in a manner permitting the post 130 to selectively rotate relative to the bracket 134 and relative to the base body 132. With this construction, then, the lid 122 is pivotably maintained relative to the opening 126 of the tank body 120.

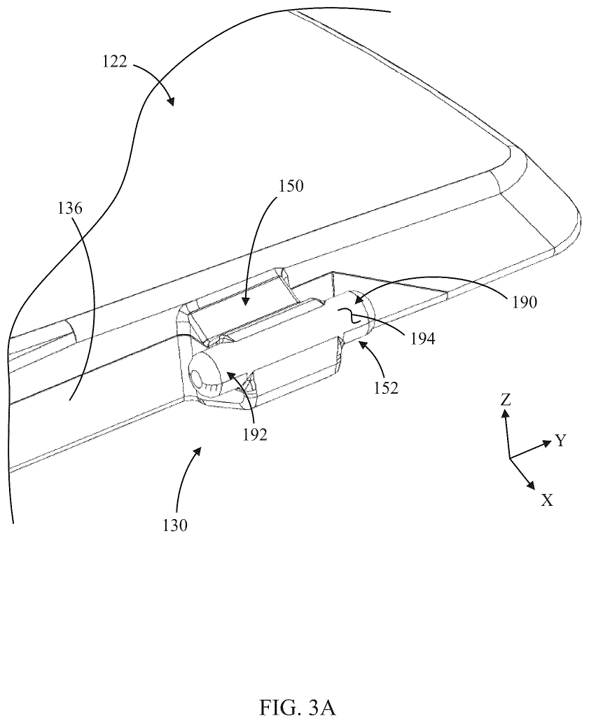

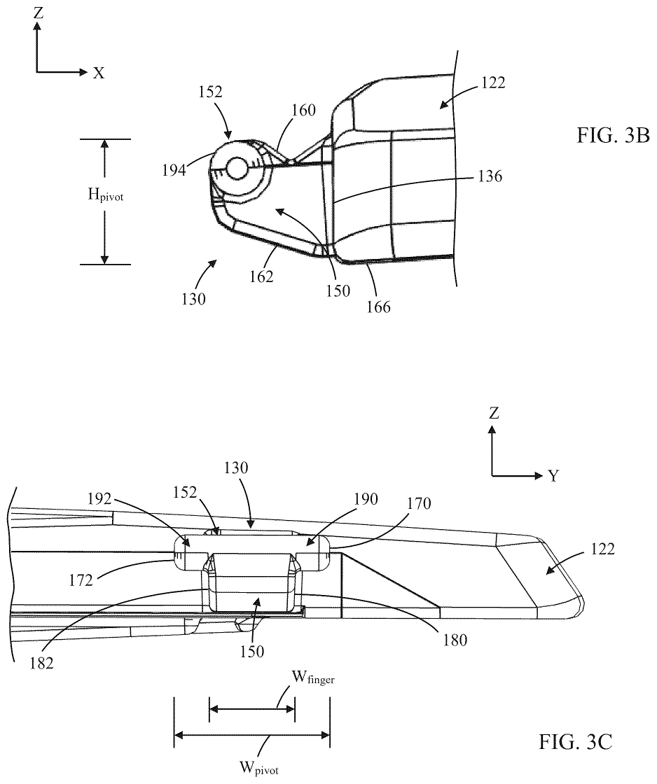

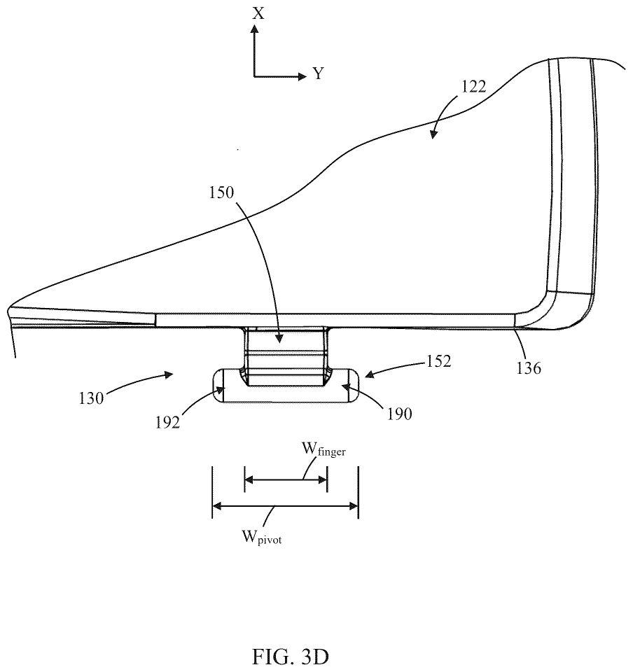

One example of the post 130 is shown in greater detail in FIGS. 3A-3D and includes a finger 150 and a pivot member 152. The finger 150 projects from the side 136 of the lid 122. In some embodiments, the post 130 is an integrally formed component or part of the lid 122 (e.g., the lid 122, including the post 130, can be a homogenous, molded plastic body (for example, a rotomolded part)), in other embodiments, the post 130 can be separately formed and subsequently attached to the lid 122. With these and other techniques, the side 136 can be a continuous, uninterrupted face of the lid 122 from which the finger 150 extends. Regardless, the pivot member 152 is formed or carried by the finger 150 opposite (and thus spaced from) the side 136 and is configured to facilitate a rotatable interface with other components of the hinge assembly 100 (FIG. 2A) as described below.

The finger 150 and the pivot member 152 can be formed to define various dimensions or geometries configured to interface with other components of the hinge assembly 100 (FIG. 2C) as described in greater detail below. For example, features of the post 130 can be described with respect to a length direction (X axis) in extension from the lid 122, a width direction (Y axis) perpendicular to the length direction, and a depth or height direction (Z axis). With these conventions in mind, the finger 150 can define various surface shapes in extension from the side 136 of the lid 122. For example, and as best seen in FIG. 3B, an upper face 160 can optionally form or define a trough-like shape configured to interface with or receive a surface of the base body 132 (FIG. 2C) in the opened position of the lid 122. A lower face 162 can optionally exhibit a generally upward (relative to the orientation of FIG. 3C) taper in extension to the pivot member 152. Other geometries or surface features are also acceptable. Regardless, the post 130 is configured to locate the pivot member 152 at a height Hₚᵢᵥₒₜ relative to a lower edge 166 of the lid 122 (i.e., a liner dimension or distance in the depth direction or along the Z axis between the lower edge 166 of the lid 122 at the side 136 and an opposing face of the pivot member 152) for reasons made clear below.

Shapes and geometries of the pivot member 152 are generally configured to promote connection to, and interface with, other components of the hinge assembly 100 (FIG. 2A). For example, and as identified in FIGS. 3C and 3D, the pivot member 152 forms opposing ends 170, 172 and defines a width Wₚᵢᵥₒₜ (i.e., a linear dimension or distance in the width direction or along the Y axis between the opposing ends 170, 172). At least in a region of the pivot member 152, the pivot member 152 projects (in at least the width direction or along the Y axis) beyond a footprint of the finger 150, and in particular beyond opposing side faces 180, 182 thereof. With these definitions in mind, the pivot member width Wₚᵢᵥₒₜ is greater than a width W_{finger} defined by the finger 150 (i.e., a linear dimension or distance in the width direction or along the Y axis between the opposing side faces 180, 182), at least in a region of the pivot member 152. Relative to the width direction (or along the Y axis), a shape of the pivot member 152 can be substantially centered relative to a shape of the finger 150, with the pivot member 152 forming or defining a first engagement region 190 and a second engagement region 192. The first engagement region 190 can be viewed or defined as an extent of the pivot member 152 from the first side face 180 of the finger 150 to the first end 170; the second engagement region can be viewed or defined as an extent of the pivot member 152 from the second side face 182 of the finger 150 to the second end 172. One or both of the engagement regions 190, 192 forms or defines a rounded surface 194 (best seen and identified in FIGS. 3A and 3B). In some embodiments, the pivot member 152 can be, or can be akin to, a cylindrical body at least along the engagement regions 190, 192. With these and related embodiments, a center axis of the circular shape defined by the engagement regions 190, 192 can be aligned and serves as an axis of rotation about which the post 130, and thus the lid 122, can rotate. Other shapes and/or configurations are also acceptable.

Returning to FIGS. 2A-2C, the base body 132 is provided apart from the lid 122 and in some optional embodiments, can be arranged to extend across a portion of the tank body 120. In other embodiments, the base body 132 can be formed or carried by other structures of the corresponding floor treatment machine away from the tank body 132. In some embodiments, the base body 132 can be configured to accommodate or maintain one or more additional components (e.g., a filter, etc.) and can be an integral, homogenous body (for example a rotomolded plastic part). Regardless, the base body 132 forms or defines the slot 138 that is otherwise sized and shaped to receive the post 130 and the bracket 134 as described in greater detail below.

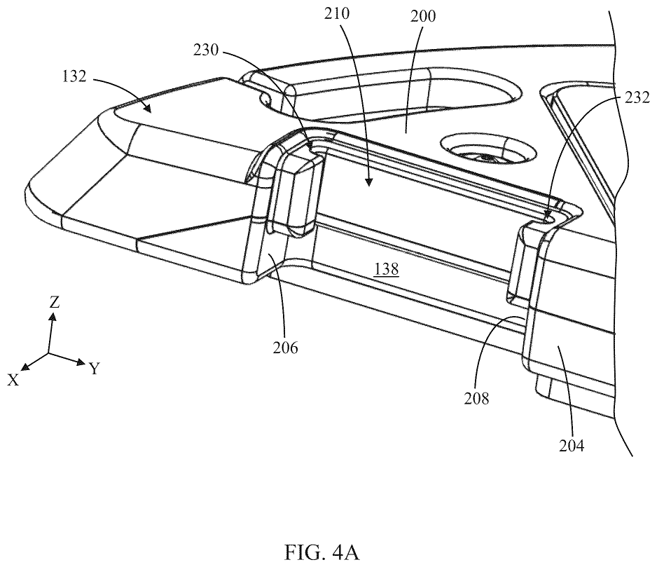

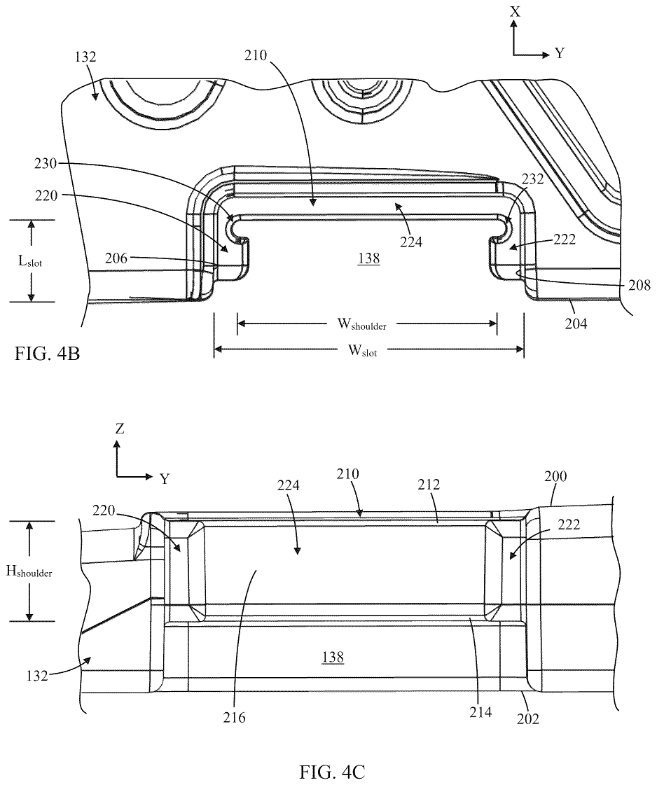

Features of the base body 132, and in particular the slot 138, can be described with respect to a length direction (X axis), a width direction (Y axis) perpendicular to the length direction, and a depth or height direction (Z axis). As shown in greater detail in FIGS. 4A-4C, the base body 132 can be viewed as defining a first or upper major surface 200 opposite a second or lower major surface 202, and a leading side surface 204 extending between the major surfaces 200, 202. The slot 138 is formed as an inward projection or recess along the leading side surface 204, and is open to the at least the upper major surface 200, optionally to both of the opposing major surfaces 200, 202. The slot 138 can be viewed as being bounded by opposing side faces 206, 208 that combine to define a width Wₛₗₒₜ (i.e., a linear dimension or distance in the width direction or along the Y axis between the opposing side faces 206, 208).

A shoulder 210 is formed or defined within the slot 138, spaced in the height direction (or along the Z axis) from the opposing major surfaces 200, 202. The shoulder 210 is configured to receive the bracket 134 (FIG. 2C) as described below, and forms a first receiving surface 212 opposite a second receiving surface 214, and a bearing surface 216 extending between the receiving surfaces 212, 214. In some examples, a shape of the shoulder 210 can define opposing, first and second side members 220, 222 and a central member 224. The first side member 220 is defined as an inward projection from the first side face 206; similarly, the second side member 222 is defined as an inward projection from the second side face 208. The central member 224 extends laterally between and interconnects the side members 220, 222. A first channel 230 is formed at an intersection of the first side member 220 and the central member 224, and is generally configured to receive a fastening body (e.g., the fastening body 140a (FIG. 2C)) as described below. For example, the first channel 230 can extend between (and thus be open relative to) the receiving surfaces 212, 214. In some embodiments, the first channel 230 is further open to the central member 224 (e.g., the first channel 230 can be viewed has having an incomplete perimeter, for example an open side that “faces” the central member 224). In some examples, a second channel 232 is formed at an intersection of the second side member 222 and the central member 224, and can be substantially identical to the first channel 230.

Various shapes and geometries of the shoulder 210 generally configured promote connection to, and interface with, other components of the hinge assembly 100 (FIG. 2C). For example, a width W_{shoulder} of the shoulder 210 can be defined as a linear distance between the first and second channels 230, 232 in the width direction (i.e., along the Y axis). A height H_{shoulder} of the shoulder 210 can be defined as a linear distance between the first and second receiving surfaces 212, 214 in the height direction (i.e., along the Z axis). The shoulder width W_{shoulder} and shoulder height H_{shoulder} are selected in accordance with corresponding features of the bracket 134 (FIG. 2C) as described below. A length Lₛₗₒₜ of the slot 138 can be defined as a linear distance between the leading side surface 204 and the bearing surface 216 in the length direction (i.e., along the X axis), and is selected to accommodate the bracket 134 and at least a portion of the post 130 (FIG. 2C).

Returning to FIGS. 2A-2C, the bracket 134 is provided apart from the lid 122 and the base body 132 and is configured to receive at least a portion of the post 130 and for connection to the base body 132. In some examples, the bracket 134 can be formed of material differing from that of the lid 122/post 130 and/or of the base body 132. In some non-limiting embodiments, the lid 132 (and thus the post 130) and the base body 132 can be formed of a plastic material (e.g., rotomolded plastic) whereas the bracket 134 is a metal or other rigid material.

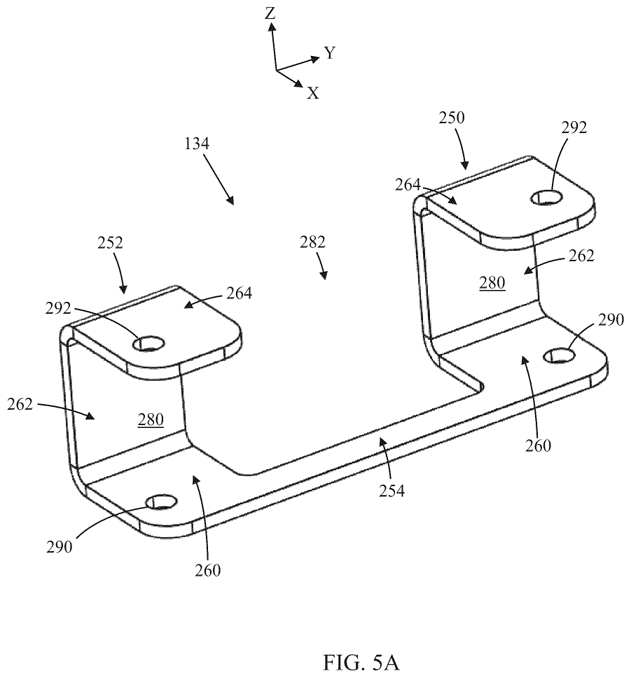

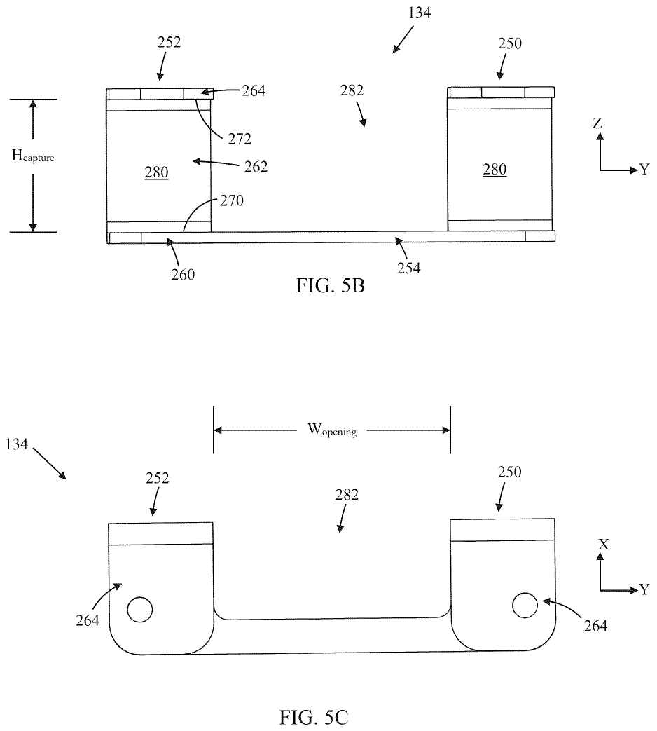

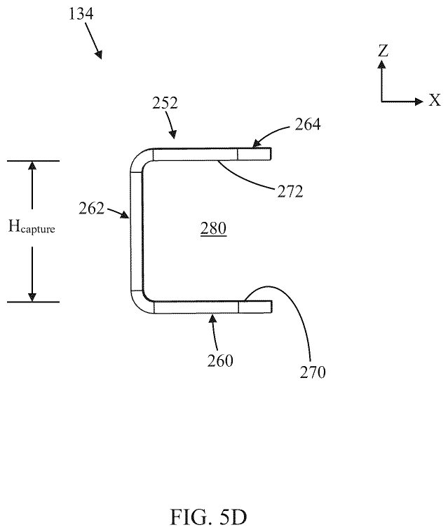

Features of the bracket 134 can be described with respect to the length direction (X axis), the width direction (Y axis) perpendicular to the length direction, and the depth or height direction (Z axis). As shown in greater detail in FIGS. 5A-5D, the bracket 134 can include a first leg 250, a second leg 252, and a cross-member 254 extending between and interconnecting the legs 250, 252. The legs 250, 252 can have a substantially similar construction, each shaped to define a first segment 260 extending from the cross-member 254, a second segment 262 extending from the first segment 260, and a third segment 264 extending from the second segment 262. The cross-member 254 can be a substantially flat or planar body (i.e., within 5 percent of a truly planar body), with each of the first segments 262 also being substantially flat and substantially co-planar (i.e., within 5 percent of a truly co-planar arrangement) with the cross-member 254. With this example configuration, the cross-member 254 and the first segments 260 combine to define a substantially flat or planar contact face 270. The second segment 262 extends from the first segment 260 and can be or define a substantially flat or planar body, with a major plane of the second segment 262 being substantially perpendicular to a major plane of the first segment 260 (i.e., within five percent of a truly perpendicular arrangement). In some examples, the leg 250, 252 can exhibit or form a curve or bend in transition from the first segment 260 to the second segment 262. The third segment 264 extends from the second segment 262 opposite the first segment 260 and can be or define a substantially flat or planar body, with a major plane of the third segment 264 being substantially perpendicular to the major plane of the second segment 262 (i.e., within five percent of a truly perpendicular arrangement). In some examples, the leg 250, 252 can exhibit or form a curve or bend in transition from the second segment 262 to the third segment 264. Regardless, the third segment 264 is generally spatially aligned with, but spaced from (in a direction of the Z axis), the corresponding first segment 260 such that the leg 250, 252 has a generally U-or C-like shape. With embodiments in which the legs 250, 252 have substantially identical configurations, an engagement face 272 defined by each of the third segments 264 are substantially co-planar with one another (i.e., within five percent of a truly co-planar relationship).

With the above construction, a capture region 280 is formed by each of the legs 250, 252 that is generally configured to capture a portion of the post 130 (FIG. 2C) as described in greater detail below. For example, an extent of the capture region 280 can be defined by a combination of the corresponding first, second, and third segments 260-264. A height H_{capture} of the capture region 280 can be defined as a linear distance between the contact face 270 of the corresponding first segment 260 and the engagement face 272 of the corresponding third segment 264, and is selected in accordance with dimensions or features of the base body 132 (FIG. 2C) as described in greater detail below. As best seen in FIGS. 5A and 5D, the bracket 134 is configured such that each of the capture regions 280 are open proximate the cross-member 254 (e.g., the capture region 280 is bounded at one side by the corresponding second segment 262, but is otherwise open or un-bounded opposite the second segment 262).

The spaced arrangement of the first and second legs 250, 252 establishes an opening 282 (referenced generally) therebetween. A width W_{opening} of the opening 282 can be defined as a linear distance between an inner edge of the first leg 250 and an inner edge of the second leg 252, and is selected in accordance with features of the post 130 (FIG. 2C) as described in greater detail below.

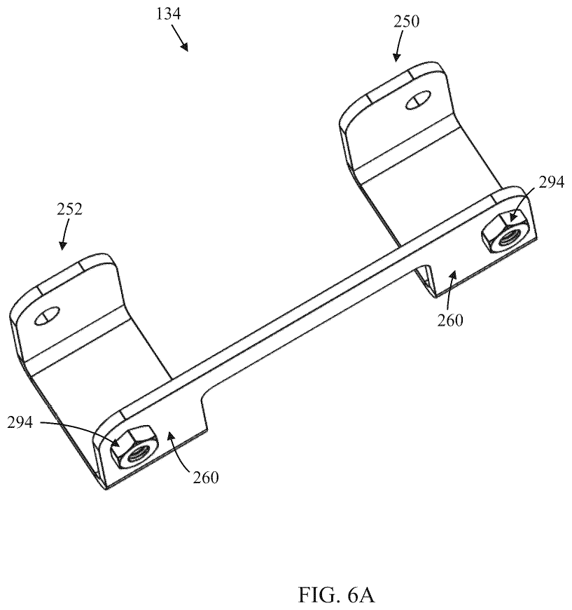

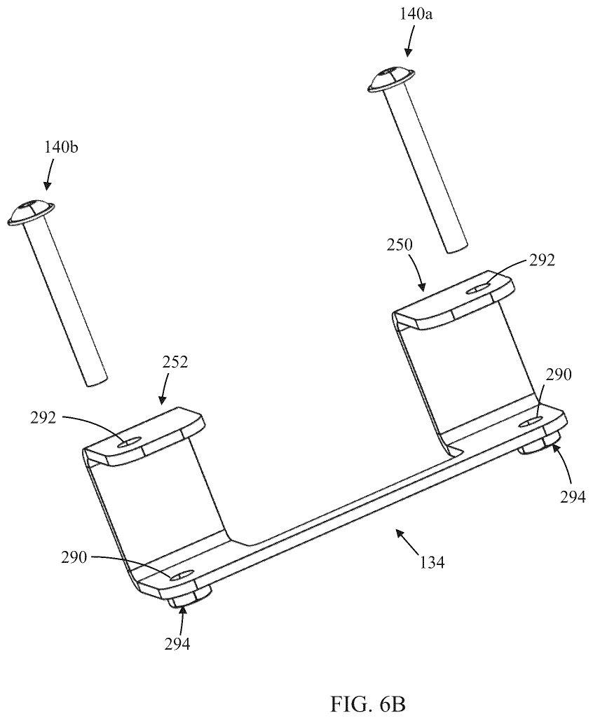

In some embodiments, the bracket 134 can include one or more features that facilitate robust assembly to the base body 132 (FIG. 2C). For example, each of the legs 250, 252 can be configured to define a first bore 290 in the first segment 260 and a second bore 292 in the third segment 264. The first and second bores 290, 292 of each of the legs 250, 252 can be spatially aligned, and generally configured to slidably receive a fastening body (e.g., one of the fastening bodies 140a, 140b shown in FIG. 2C). With these and related embodiments, one or more additional components can be provided with the bracket 134 that facilitate connection with the fastening body. For example, and as shown in FIG. 6A, with embodiments in which the fastening body includes a threaded surface (e.g., a screw), a complementary engagement member (e.g., an interiorly threaded nut) 294 can be mounted (e.g., welded) to an outer surface of each of the first segments 260 in alignment with the corresponding first bore 290 (hidden in FIG. 6A). With this but one acceptable construction, and as represented by FIG. 6B, the first fastening body 140a can be connected to the first leg 250 by insertion through the corresponding first and second bores 290, 292 and then threadably secured to the corresponding engagement member 294. The second fastening body 140b can be similarly connected and secured to the second leg 252.

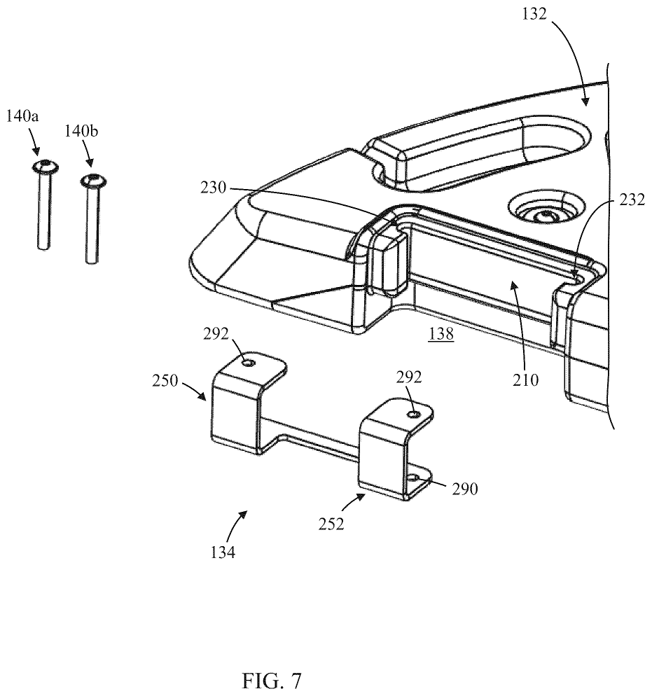

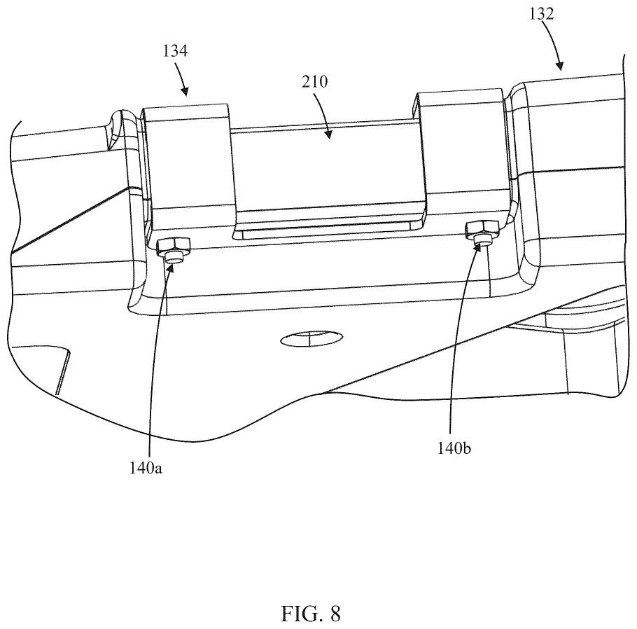

Returning to FIGS. 2A-2C, the post 130, the base body 132, and the bracket 134 can be assembled to one another to form the hinge assembly 100 in various manners. For ease of understanding, a relationship and arrangement of the bracket 134 and the base body 132 are first described apart from the post 130. With this in mind, FIG. 7 illustrates the bracket 134 poised for assembly to the base body 132. With additional reference to FIGS. 4A and 5A, the bracket 134 and the slot 138 have a corresponding size and shape such that the bracket 134 can nest within the slot 138, with the legs 250, 252 engaging the shoulder 210. For example, the width Wₛₗₒₜ (FIG. 4B) of the slot 138 is sized to accommodate a footprint of the bracket 134. Further, the height H_{shoulder} (FIG. 4C) of the shoulder 210 corresponds with the height H_{capture} (FIG. 5B) of the capture region 280 of each of the legs 250, 252 such that the bracket 134 readily fits over the shoulder 210. With optional embodiments in which one or more of the fastening bodies 140a, 140b are employed, upon final arrangement of the bracket 134 over the shoulder 210, the first and second bores 290, 292 of the first leg 250 are aligned with the first channel 230, and the first and second bores 290, 292 of the second leg 252 are aligned with the second channel 232. With the bracket 134 fully inserted over the shoulder 210, then, the first fastening body 140a can be readily secured to the first leg 250 by insertion through the corresponding second bore 292, the first channel 230, and the corresponding first bore 290. Where the first fastening body 140a provides a threaded surface, the so-inserted first fastening body 140a can then be threadably secured to the corresponding engagement member 294 (FIG. 6A) carried by the first leg 250. The second fastening body 140b can similarly be secured to the second leg 252, extending through the second channel 232. FIG. 8 illustrates final assembly of the bracket 134 to the base body 132. The hinge assemblies of the present disclosure can alternatively incorporate other features or components that facilitate mounting of the bracket 134 to the base body 132 that may or may not entail the fastening bodies 140a, 140b.

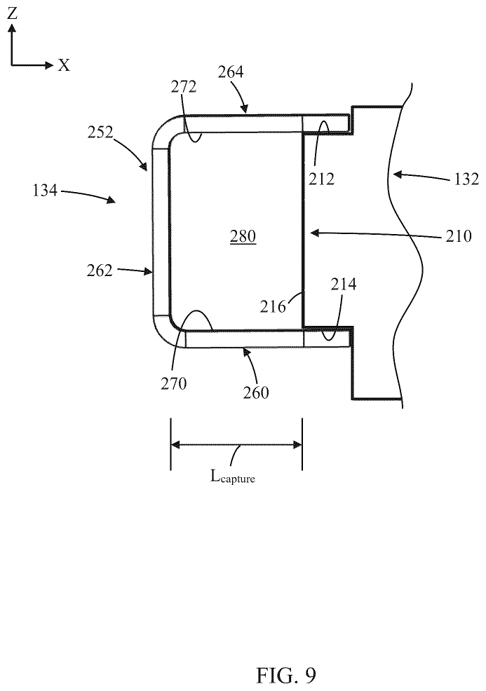

Regardless of the exact techniques employed, FIG. 9 generally reflects arrangement of the second leg 252 relative to the shoulder 210 upon final assembly. The engagement face 272 of the third segment 264 bears against the first receiving surface 212 of the shoulder 210, and the contact face 270 of the first segment 260 bears against the second receiving surface 214. The capture region 280 is closed or bounded by the bearing surface 216 of the shoulder 210. Upon final assembly to the base body 132, then, an effective length L_{capture} of the capture region 280 can be defined as a linear distance (along the X axis) between the bearing surface 216 of the shoulder 210 and an inner face of the second segment 262. The capture region length L_{capture} and the capture region height H_{capture} (FIG. 5B) are selected to generally receive and maintain a portion of the post 130 (FIG. 2B) as described below.

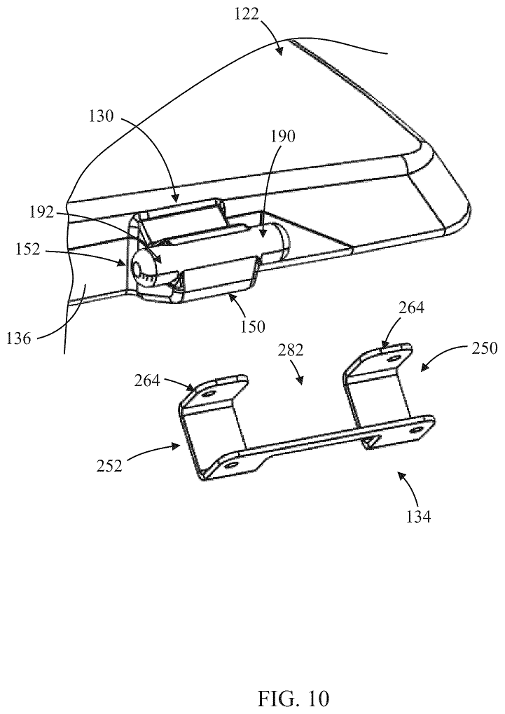

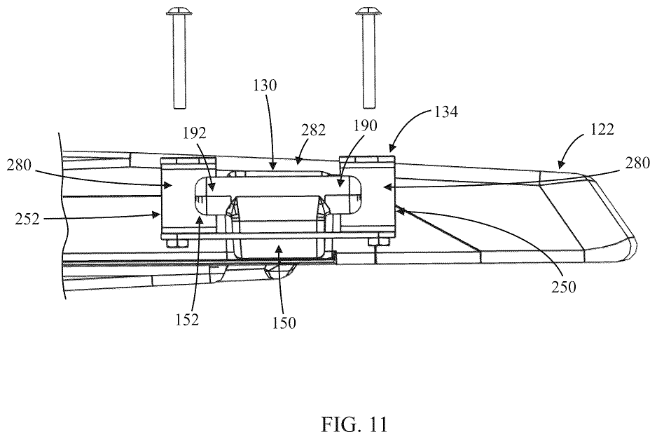

Returning to FIGS. 2A-2C, the bracket 134 can be connected to the post 130 in various fashions. For ease of understanding, a relationship and arrangement of the post 130 and the bracket 134 are next described apart from the base body 132. With this in mind, FIG. 10 illustrates the bracket 134 poised for assembly to the post 130. As a point of reference, the optional engagement members 294 (FIG. 6A) are omitted from the view of FIG. 10 for ease of illustration. With additional reference to FIGS. 3C and 5C, the width W_{opening} of the opening 282 of the bracket 134 is greater than the width W_{finger} of the finger 150 and is less than the width Wₚᵢᵥₒₜ of the pivot member 152. With the opening 282 aligned with the post 130, the bracket 134 can be articulated or rotated (as generally reflected by FIG. 10) such that the third segment 264 of the first leg 250 can be inserted between the first engagement region 190 of the pivot member 152 and the side 136 of the lid 122, and the third segment 264 of the second leg 252 can be inserted between the second engagement region 192 and the side 136. From this arrangement, the bracket 134 can then be rotated relative to the post 130 such that the first engagement region 190 of the pivot member 152 is disposed within the capture region 280 of the first leg 250, and the second engagement region 192 is disposed within the capture region 280 of the second leg 250 as shown in FIG. 11. FIG. 11 further reflects that while the pivot member 152 is effectively captured by the bracket 134, the finger 150 is entirely within the opening 282 and is otherwise free of the legs 250, 252.

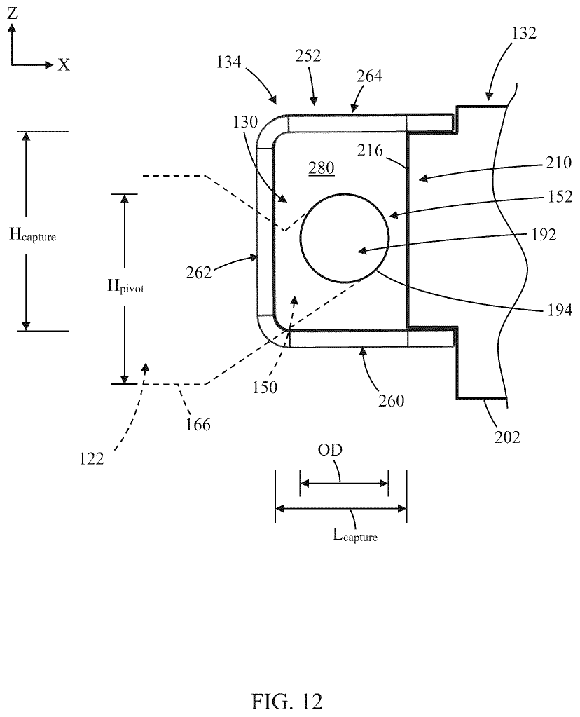

With the above explanations in mind, and returning to FIGS. 2A-2C, the hinge assembly 100 can be completed by connecting the bracket 134 to the post 130 as described above (e.g., to the arrangement of FIG. 11), followed by assembly of the bracket 134 (with the post 130 retained by the bracket 134) to the base member 132 (e.g., to the arrangement of FIG. 7). A relationship of the pivot member 152 relative to the base body 132 and the bracket 134 upon final construction is reflected by the simplified cross-sectional view of the FIG. 12. In particular, FIG. 12 reflects the second engagement region 192 of the pivot member 152 disposed within the capture region 280 of the second leg 252. For ease of understanding, portions of the finger 150 and the lower edge 166 of the lid 122 when in the closed position are schematically represented by dash lines in the view of FIG. 12. Commensurate with the descriptions above, a geometry of the finger 150 locates the pivot member 152 at the known height Hₚᵢᵥₒₜ relative to the lower edge 166; under circumstances in which the lower edge 166 is exteriorly supported in the closed position (e.g., by or against the tank body 120 (FIG. 2C)) at an expected spatial location relative to the lower major surface 202 of the base body 132, the pivot member 152 will be spaced (along the Z axis) from the first and third segments 260, 264 of the second leg 252 as shown.

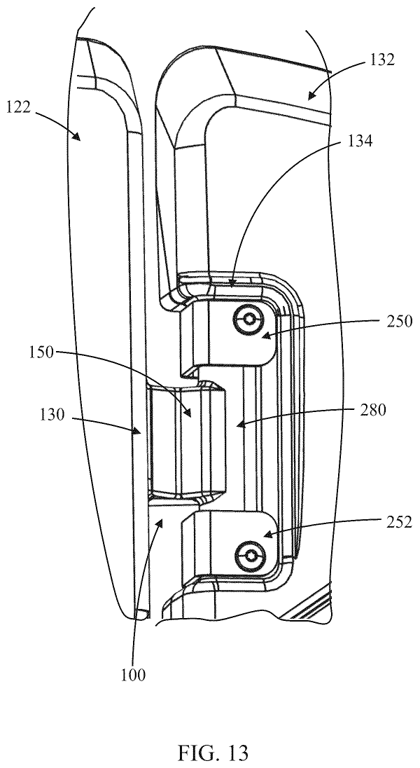

Upon final assembly, the capture region 280 is bounded or closed by the bearing surface 216 of the shoulder 210 such that the second engagement region 192 is completely captured within the capture region 280. An outer dimension (e.g., outer diameter) OD of the second engagement region 192 is less than the capture region length L_{capture} and the capture region height H_{capture}. With this arrangement, and with additional reference to FIG. 13 (that otherwise illustrates the hinge assembly 100 upon final construction with the lid 122 in the closed position), depending upon a longitudinal position of the lid 122 relative to the base body 132 along the X axis, the rounded surface 194 of the second engagement region 192 can be brought into contact with the second segment 262 of the second leg 252 or the bearing surface 216 of the shoulder 210. At either position, the rounded surface 194 provides a rotational interface, facilitating rotational movement of the pivot member 152 (and thus of the post 130 and the lid 122) relative to the base member 132 and/or the bracket 134 about a center axis of the second engagement region 192. A similar, rotationally-captured arrangement is provided between the pivot member 152 and the capture region 280 of the first leg 250 (FIG. 2C). As best seen in FIG. 13, the finger 150 is within the opening 282 of the bracket 134, spaced away from the legs 250, 252. Thus, the finger 150 does not contact the bracket 134 with rotation of the lid 122 from the closed position of FIG. 2A or otherwise impede rotation to the opened position of FIG. 2B.

With specific reference to FIG. 12, because the outer dimension OD of the second engagement region 192 is less than the capture region height H_{capture}, the pivot member 152 (and thus the post 130 and the lid 122) can move laterally (along the Z axis) relative to the base body 132 within the capture region 280. With these and related embodiments, and with additional reference to FIG. 2A, when rotated to the closed position represented by FIGS. 2A and 12, the lid 122 can be further articulated toward the tank body 120. For example, where the tank unit 110 includes the gasket 134 (e.g., assembled to an underside of the lid 122), when the lid 122 is in the closed position and the interior cavity 130 is placed under negative pressure, the lid 122 is permitted to be drawn closer to the tank body 120 by the first engagement region 190 sliding (along the Z axis) within the capture region 280 thus desirably promoting the gasket 134 being placed under compression to effectuate a more complete seal between the lid 122 and the tank body 120.

The hinge assemblies of the present disclosure, and floor treatment machines incorporating the hinge assembly, provide a marked improvement over previous designs. The hinge assemblies of the present disclosure attaches by clamping onto the base body that can otherwise be a plastic (e.g., rotomolded) part rather than with direct fastening. This allows for easier accesses to the fasteners for assembly as compared to conventional designs. Further, the relatively straightforward or simple shape of the bracket allows for more adjustment to fit tolerances of the base body (e.g., where the base body is a plastic (e.g., rotomolded) part) and desired movement for compression of an optional gasket between the lid and the tank body.

Although the present disclosure has been described with reference to preferred embodiments, workers skilled in the art will recognize that changes can be made in form and detail without departing from the spirit and scope of the present disclosure.

What is claimed is:

1. A hinge assembly for pivotably maintaining a lid relative to an opening of a tank body of a floor treatment machine, the hinge assembly comprising:
a post projecting from a side of the lid;
a base body defining a slot; and
a bracket configured for connection to the base body in a region of the slot;
wherein upon final assembly, the bracket captures the post within the slot in a manner permitting the post to selectively rotate relative to the bracket and relative to the base body.

2. The hinge assembly of claim 1, wherein the bracket defines a capture region configured to capture the post, and further wherein a height of the capture region is greater than a height of the post such that the post is laterally moveable relative to the bracket and the base body upon final assembly.

3. The hinge assembly of claim 1, wherein the post includes a finger extending from the side of the lid and a pivot member carried by the finger opposite the side.

4. The hinge assembly of claim 3, wherein the pivot member defines a rounded surface configured to bear against a surface of the bracket and the base body upon final assembly.

5. The hinge assembly of claim 3, wherein the post defines a length direction in extension from the lid and a width direction perpendicular to the length direction, and further wherein a width of the pivot member in the width direction is greater than a width of the finger in the width direction.

6. The hinge assembly of claim 5, wherein the bracket defines an opening configured to receive the finger, and further wherein a width of the opening is greater than the width of the finger and is less than the width of the pivot member.

7. The hinge assembly of claim 1, wherein the base body defines an upper surface opposite a lower surface and a side surface extending between the upper and lower surfaces, and further wherein the slot is defined by an inward projection of the side surface and is open to at least the upper surface.

8. The hinge assembly of claim 7, wherein the base body forms a shoulder in a region of the slot, and further wherein the shoulder is configured to engage a surface of the bracket upon final assembly.

9. The hinge assembly of claim 8, wherein the shoulder defines a first channel, and wherein the hinge assembly further includes a first fastening body configured to pass through the first channel and secure the bracket relative to the base body.

10. The hinge assembly of claim 9, wherein the shoulder further defines a second channel, and wherein the hinge assembly further includes a second fastening body configured to pass through the second channel and secure the bracket relative to the base body.

11. The hinge assembly of claim 9, wherein upon final assembly, the bracket is clamped onto the shoulder via the first fastening body.

12. The hinge assembly of claim 1, wherein the bracket includes a cross-member terminating at opposing, first and second sides, a first leg extending from the cross-member proximate the first side, and a second leg extending from the cross-member proximate the second side, and further wherein an opening is defined between the first and second legs.

13. The hinge assembly of claim 12, wherein the first leg defines a first segment extending from the cross-member and a second segment spaced from, and opposite of, the first segment.

14. The hinge assembly of claim 13, wherein the second segment is spatially aligned with the first segment, and wherein the hinge assembly further includes a fastening member configured to extend between and interconnect the first segment and the second segment.

15. The hinge assembly of claim 1, wherein the post and the base body are formed of a plastic material, and the bracket is formed of a metal material.

16. The hinge assembly of claim 1, wherein:
the post includes a finger extending from the side of the lid and a pivot member carried by the finger opposite the side;
the post defines a length direction in extension from the lid and a width direction perpendicular to the length direction, and further wherein a width of the pivot member in the width direction is greater than a width of the finger in the width direction;
the base body forms a shoulder in a region of the slot;
the bracket includes a cross-member, a first leg, and a second leg, further wherein an opening is defined between the first and second legs, a width of the opening being greater than the width of the finger and less than the width of the pivot member;
wherein upon final assembly, the finger is received within the opening and the legs are secured to the shoulder, with the pivot member selectively bearing against a surface of the bracket.

17. The hinge assembly of claim 16, wherein the shoulder defines a channel, and further wherein the hinge assembly includes a fastening body configured to pass through the channel to secure the first leg to the shoulder.

18. The hinge assembly of claim 17, wherein the fastening body includes a shaft defining a threaded surface, and wherein the hinge assembly further includes an engagement body carried by the bracket and configured to threadably engage the threaded surface of the fastening body.

19. A floor treatment machine comprising:
a chassis;
at least one floor treating implement carried by the chassis; and
a tank unit carried by the chassis, wherein the tank unit includes a tank body, a lid, and a hinge assembly pivotably maintaining the lid relative to an opening of the tank body, the hinge assembly including:
a post projecting from a side of the lid,
a base body defining a slot,
a bracket configured for connection to the base body in a region of the slot,
wherein upon final assembly, the bracket captures the post within the slot in a manner permitting the post to selectively rotate relative to the bracket and relative to the base body.

20. The floor treatment machine of claim 19, wherein the at least one cleaning implement is selected from the group consisting of a scrubber, a sweeper, an extractor, and a squeegee.
